(19) United States
(12) Patent Application Publication
(10) Pub. No.: US 2022/0055452 A1
(43) Pub. Date: Feb. 24, 2022

(54) REFRIGERATION SYSTEM FOR TRANSPORT VEHICLE, CONTROL METHOD THEREOF AND TRANSPORT VEHICLE

(71) Applicant: CARRIER CORPORATION, PALM BEACH GARDENS, FL (US)

(72) Inventors: Linhui Chen, SHANGHAI (CN); Xiaojuan Wu, SHANGHAI (CN)

(21) Appl. No.: 17/252,548

(22) PCT Filed: May 4, 2020
(86) PCT No.: PCT/US2020/031313

§ 371 Date: Dec. 15, 2020

(30) Foreign Application Priority Data
May 7, 2019 (CN) 201910375367.4

(51) Int. Cl. B60H 1/32; B60H 1/22; B60H 1/00; B60P 3/20

(52) U.S. Cl. CPC B60H 1/3202; B60H 1/2227; B60H 1/00014; B60H 2001/3255; B60P 3/20; B60H 2001/328; B60H 1/3233

(57) ABSTRACT

The refrigeration system is configured to adjust a temperature inside a vehicle compartment of the transport vehicle, the refrigeration system including an evaporator disposed in the vehicle compartment and the evaporator including evaporator coils (120) through which a refrigerant flows and a housing (110) for accommodating the evaporator coils; wherein the housing is further provided with a heating element (130); and the refrigeration system further includes a control module (140) configured to control the heating element. According to the refrigeration system for a transport vehicle, the control method thereof and the transport vehicle of the present disclosure, by disposing the heating element inside the housing of the evaporator, which is controlled to perform heating and stop heating according to actual situations, ice is prevented from being formed on the inner side of the housing, and condensation water is prevented from being formed on the outer side of the housing, thereby effectively improving the reliability of the preservation of goods.

### CROSS REFERENCE TO RELATED APPLICATIONS

This application claims the benefit of CN Application No. 201910375367.4, filed on May 7, 2019, which is incorporated herein by reference in its entirety.

### FIELD OF THE INVENTION

The present disclosure relates to the field of transportation refrigeration, and in particular, to a refrigeration system for a transport vehicle and a control method thereof.

### BACKGROUND OF THE INVENTION

Transport vehicles are an indispensable part of the cold chain and are usually equipped with dedicated refrigeration systems. Such refrigeration systems typically include a compressor, a condenser, an evaporator, an electronic expansion valve, and other auxiliary components that form a refrigeration circuit. The evaporator of the refrigeration system is usually arranged in a compartment of the transport vehicle which is used to provide a constant-temperature storage space for the goods to be transported, such as refrigeration or freezing storage. Such evaporators generally have a housing which can be used on one hand to protect internal components, and on the other hand, as a water receiving tray, on which a drain pipe can be provided for discharging condensation water, produced in the evaporator during defrosting or other processes, to the outside of the vehicle in time. However, in some cases, problems of unsmooth drainage may occur. For example, if the vehicle is parked at an inappropriate position, when the front of the vehicle is tilted and it is thus difficult for the water in the water receiving tray to be discharged through the drain pipe, the water receiving tray may freeze; or when the refrigeration system uses a defrost mode to apply overheated refrigerant vapor inside the evaporator, it will be difficult for the large amount of condensation water precipitated on evaporator coils to be discharged from the bottom of vehicle through the drain pipe, and the water receiving tray will also freeze. In addition, when the user opens the compartment, due to a significant temperature difference between the outside ambient temperature and the thermal insulation temperature inside the compartment, for example, 30° C. versus −20° C., more condensation water may be generated in the compartment, and it is formed on the evaporator housing due to condensation. Then, the water drips into the compartment via the housing, and is highly likely to drip onto the goods in the compartment, thereby damaging the goods.

### SUMMARY OF THE INVENTION

The present disclosure aims to provide a refrigeration system, a control method thereof, and a transport vehicle that reduce the generation of condensation water in a vehicle compartment.

In order to achieve the object of the present disclosure, according to an aspect of the present disclosure, a refrigeration system for a transport vehicle is provided, which is configured to adjust a temperature inside a vehicle compartment of the transport vehicle, the refrigeration system including an evaporator disposed in the vehicle compartment, and the evaporator including evaporator coils through which a refrigerant flows and a housing for accommodating the evaporator coils; wherein the housing is further provided with a heating element; and the refrigeration system further includes a control module configured to control the heating element.

Optionally, the heating element is built into the housing, and/or the heating element is disposed on a surface of the housing.

Optionally, in a case that the material of the housing has a coefficient of thermal conductivity lower than a first preset value, the heating element is disposed on an inner side and an outer side of the surface of the housing respectively; or in a case that the material of the housing has a coefficient of thermal conductivity higher than a second preset value, the heating element is disposed on an inner side or an outer side of the surface of the housing; wherein the first preset value is less than the second preset value.

Optionally, in a case that the material of the housing has a coefficient of thermal conductivity lower than a third preset value, the housing is further provided with a heat conductive member, the heat conductive member is built in the housing, and/or the heat conductive member is disposed on the surface of the housing; wherein a heating element is disposed in the heat conductive member and is configured to transfer heat to the housing via the heat conductive member.

Optionally, the refrigeration system further includes a water receiving tray, wherein a lower portion of the housing serves as the water receiving tray, or the water receiving tray is accommodated inside the housing; and wherein the heating element is disposed at the lower portion of the housing and is positioned near the water receiving tray.

Optionally, the refrigeration system further includes a temperature sensor disposed on an inner side of the housing and/or an outer side of the housing; and the control module controls activation/deactivation of the heating element based on an inner side temperature of the housing and/or an outer side temperature of the housing sensed by the temperature sensor.

Optionally, the heating element includes carbon fibers.

In order to achieve the object of the present disclosure, according to another aspect of the present disclosure, a transport vehicle is further provided, which includes the refrigeration system as described above, and a vehicle compartment.

Optionally, the vehicle compartment includes a compartment door, on which a compartment door sensor is disposed; wherein when the compartment door is opened, the compartment door sensor transmits a signal to the control module of the refrigeration system, and the control module controls the heating element to be activated.

In order to achieve the object of the present disclosure, according to still another aspect of the present disclosure, a control method of a refrigeration system for a transport vehicle is provided, wherein the refrigeration system includes an evaporator disposed in a vehicle compartment, and the evaporator includes evaporator coils through which a refrigerant flows and a housing for accommodating the evaporator coils; wherein the housing is further provided with a heating element; the method comprises the following steps: the heating element is activated when a defrosting mode of the refrigeration system is activated or during an operation in the defrosting mode; and/or the heating element continues being activated when a cooling mode is re-entered after the defrosting is completed; and/or the heating element is activated when the vehicle compartment is opened.

Optionally, the heating element is deactivated when the inner side temperature of the housing is higher than a freezing point temperature by a first preset value; and/or the heating element is deactivated when the outer side temperature of the housing is higher than the dew point temperature by a second preset value.

Optionally, the first preset value is 4° C.-5° C.; and the second preset value is 10° C.

According to the refrigeration system for a transport vehicle, the control method thereof and the transport vehicle of the present disclosure, by disposing the heating element for the housing of the evaporator, which is controlled to perform heating and stop heating according to actual situations, ice is prevented from being formed on the inner side of the housing, and condensation water is prevented from being formed on the outer side of the housing, thereby effectively improving the reliability of the preservation of goods.

### BRIEF DESCRIPTION OF THE DRAWINGS

FIG. 1 is a schematic diagram of an embodiment of an evaporator of a refrigeration system of the present disclosure and a control portion of a heating element thereof;

FIG. 2 is a schematic diagram of another embodiment of an arrangement relationship between a housing of the evaporator housing and the heating element of the present disclosure; and

FIG. 3 is a schematic diagram of an embodiment of an arrangement relationship between the heating element and a heat conductive member of the present disclosure.

### DETAILED DESCRIPTION OF THE EMBODIMENT(S) OF THE INVENTION

An embodiment of a refrigeration system is provided herein by the present disclosure, which is configured to adjust the temperature inside a compartment of a transport vehicle. Since this improvement focuses on the evaporator portion, disposed in the transportation compartment, of the refrigeration system, components and arrangements of the interior portions of the vehicle compartment will be mainly described below with reference to the accompanying drawings. Since a plurality of orientational terms are used in the description of the technical solutions, features of the housing are used herein as an example for collectively explanation and for distinguishing. For example, the inner side of the housing indicates a side on which other parts are accommodated, while the outer side indicates a side which is exposed to the environment. As another example, the interior of the housing indicates a place in the space occupied by the product itself, while the exterior of the housing indicates a place other than the space occupied by the product itself, which may include the outer side and the inner side of the housing. Furthermore, the upper portion, middle portion or lower portion of the housing indicate a part of the space occupied by the product itself. By way of example, the lower portion of the housing indicates a lower portion of the space occupied by the product itself. Although orientational relationships of words have been described above by taking the housing as an example, they can also be applied to other features in this document, and a repeated description is omitted herein.

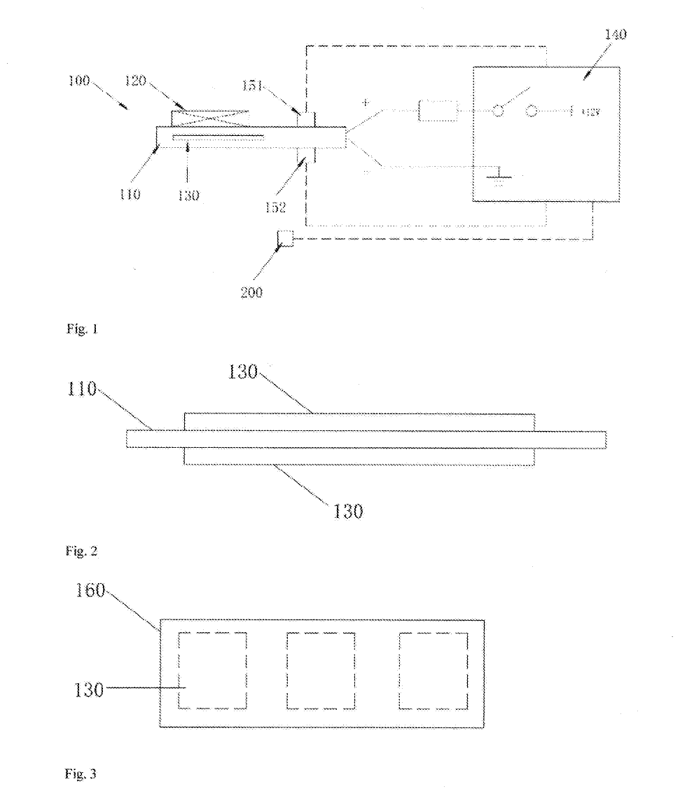

Referring to FIG. 1, the refrigeration system includes an evaporator disposed inside a vehicle compartment, and the evaporator includes evaporator coils 120 through which a refrigerant flows, and a housing 110 for accommodating the evaporator coils 120. The housing can be used on one hand to protect components within the housing, including the evaporator coils 120 mentioned above, and an evaporator fan and a water receiving tray that are not mentioned but are equally likely to exist. On the other hand, in a case that the water receiving tray is not separately provided, the lower portion of the housing 110 can also be directly used as the water receiving tray, and a drain pipe is provided on the lower portion for discharging the condensation water inside the housing. In addition, more critically, the housing 110 has a heating element 130 therein; and the refrigeration system further includes a control module 140 for controlling the heating element 130; wherein the control module can be dedicated to controlling the heating element, or it is part of the refrigeration system's own control unit. Under this arrangement, the heating element can be controlled to perform heating and stop heating according to the actual situation, thereby preventing ice from being formed on the inner side of the housing, and condensation water from being formed on the outer side of the housing, and effectively improving the reliability of the preservation of the goods and the reliability of the system itself.

Specifically, for example, if the vehicle is parked at an inappropriate position, when the front of the vehicle is tilted and it is thus difficult for the water in the water receiving tray to be discharged through the drain pipe, the water receiving tray may freeze; or when the refrigeration system uses a defrost mode to apply overheated refrigerant vapor inside the evaporator, it will be difficult for the large amount of condensation water precipitated on the evaporator coils to be discharged from the bottom of vehicle through the drain pipe, and the water receiving tray will also freeze. In the event of such a situation or before such a situation is about to occur, the heating element can be controlled to be activated, which transfers heat to the condensation water inside the housing by heating the housing, thereby avoiding freezing and congestion, and making it possible for the condensation water to be discharged orderly. For another example, when the user opens the compartment, due to a significant temperature difference between the outside ambient temperature and the thermal insulation temperature inside the compartment, for example, the outside ambient temperature of 30° C. versus the thermal insulation temperature of −20° C. inside the compartment, more condensation water may be generated in the compartment, and it is formed on the evaporator housing due to condensation. Then, the water drips into the compartment via the housing, and is highly likely to drip onto the goods in the compartment, thereby damaging the goods. In the event of such a situation or before such a situation is about to occur, the heating element can be controlled to be activated, which transfers heat to the outer side of the housing by heating the housing, thereby preventing condensation water from being generated, and also preventing the goods from being wetted and damaged.

An embodiment of the refrigeration system has been described above in connection with FIG. 1, in which the heating element 130 is built into the housing 110. Referring to FIG. 2, in fact, the heating element can also be disposed on a surface of the housing 110. It also serves to heat the housing 110, and the complex process of building-in the heating element can also be omitted. Since the housing 110 has an inner side surface and an outer side surface, and both the inner side and the outer side need to be heated to satisfy different conditions, it is conceivable to provide the heating element on both the inner side and outer side of the housing respectively, or to provide the heating element on only one of the inner side and outer side of the housing when the thermal conductive performance is good enough. For example, when the material for manufacturing the housing 110 has a coefficient of thermal conductivity higher than a second preset value, such as a metal material, the housing is considered to have sufficiently good thermal conductive performance, and the heating element 130 may be disposed only on the inner side or the outer side of the surface of the housing 110 in this situation. The heat generated thereby can be transferred to the other side where the heating element is not disposed via the housing. For another example, when the material for manufacturing the housing 110 has a coefficient of thermal conductivity lower than a first preset value which is less than the second preset value, such as a plastic material, the thermal conductive performance of the housing is considered to be not prominent enough. In this situation, the heating element 130 can be disposed on both the inner side and the outer side of the surface of the housing 110 respectively, so that the heating requirements of both sides in different situations can be satisfied.

Furthermore, the following facts are considered: some of the materials for manufacturing the heating element cannot be easily machined to have a large area, whereas a heating element having a smaller area may only achieve rapid temperature rise in the peripheral area where it is disposed. In view of this, if the material for manufacturing the housing has a coefficient of thermal conductivity lower than a third preset value, it is considered that the thermal conductive performance of the housing is not sufficiently prominent, and a component having a heat conduction function may be required to continuously conduct heat generated by the heating element to more areas on the housing. Referring to FIG. 3, in this situation, a heat conductive member 160 is further disposed on the housing, and the heat conductive member 160 is built in the housing, or the heat conductive member 160 is disposed on the surface of the housing; wherein a plurality of small pieces of the heating elements 130 are disposed in the heat conductive member 160 and transfer heat to most of the areas of the housing via the heat conductive member 160.

In addition, on the basis of the foregoing solutions, several improvements can be made to some of the details, which will be exemplarily explained as follows.

For example, in a case that the evaporator does not have a water receiving tray, the lower portion of the housing 110 may be directly used as the water receiving tray; a separate water receiving tray may also be provided and accommodated inside the housing 110. Regardless of which of the foregoing arrangements or other unlisted arrangements is employed, the heating element 130 should in any case be built into the portion of the housing 110 that is adjacent to the water receiving tray. For example, since the water receiving tray is used for drainage, it is usually disposed at a lower-height position, so that the heating element 130 can be built into the lower portion of the housing 110.

As another example, it should be understood that the activation/deactivation of the aforementioned heating element in different scenarios can be achieved either by human control or by setting the heating activation/deactivation conditions of the heating element. When setting the heating activation/deactivation conditions, for example, when setting the temperature to be the activation/deactivation control condition, usually the corresponding hardware should also be provided. Therefore, the system may also include temperature sensors 151, 152. The temperature sensor 151 is disposed on the inner side of the housing 110, and the temperature sensor 152 is disposed on the outer side of the housing 110. In this situation, the control module 140 controls the activation/deactivation of the heating element 130 based on the inner side temperature of the housing 110 sensed by the temperature sensor 151 and/or the outer side temperature of the housing 110 sensed by the temperature sensor 152.

Furthermore, with regard to the heating element itself, it can also be modified so that the objects of the foregoing embodiments can be better achieved. For example, in terms of the material, carbon fibers or electric heating wires may be employed, and in terms of the shape, a sheet shape or a filament shape may be employed. As an example, when sheet-shaped carbon fibers are used as the heating element, on the one hand, they have better heating uniformity; and on the other hand, the carbon fibers can be heated to a corresponding degree more quickly, and thus can heat the housing to a desired temperature within a very short time interval after the compartment door is opened, thereby ensuring its anti-condensation effect. In addition, the carbon fibers are directly powered by 12V DC, making them well match the conventional power supply in existing transport vehicles.

Furthermore, although not shown in the drawings, a transport vehicle is further provided herein. The transport vehicle includes the refrigeration system described in any of the foregoing embodiments or combinations thereof; it also includes a vehicle compartment for placing an evaporator of the refrigeration system. Under such an arrangement, the heating element can be controlled to perform heating and stop heating according to the actual situation, thereby preventing ice from being formed on the inner side of the housing, and condensation water from being formed on the outer side of the housing, and effectively improving the reliability of the preservation of the goods and the reliability of the system itself.

On the basis of the foregoing solutions, several improvements can be made to some of the details, which will be exemplarily explained as follows.

For example, the vehicle compartment also includes a compartment door on which a compartment door sensor 200 is disposed. When the compartment door is opened, the compartment door sensor 200 transmits a signal to the control module 140 of the refrigeration system, and the control module 140 controls the heating element 130 to be activated, at which time the heating element 130 can make a response immediately after when the compartment door is opened, thereby rapidly heating the housing 110 and preventing water droplets from being generated due to condensation.

It should be understood that the foregoing embodiments can be implemented either by human control or by setting the heating activation/deactivation conditions of the heating element. When the solution is implemented by setting the heating activation/deactivation conditions, a corresponding control method can also be provided. The refrigeration system to which the control method is applied should include an evaporator disposed in the vehicle compartment, wherein the evaporator includes evaporator coils 120 through which the refrigerant flows, and a housing 110 for accommodating the evaporator coils 120, and a heating element 130 is built into the housing 110. Specifically, the control method includes: activating the heating element 130 when a defrosting mode of the refrigeration system is activated or during an operation in the defrosting mode, thereby preventing the water accumulated on the water receiving tray from be frozen; continuing the activation of the heating element 130 when a cooling mode is re-entered after the defrosting is completed, thereby preventing the condensation water from being frozen due to rapid temperature drop; or activating the heating element 130 when the vehicle compartment is opened, thereby preventing condensation water from being precipitated and formed on the housing due to heat exchange between the low-temperature air inside the compartment and the high-temperature air outside the compartment. Alternatively, the aforementioned control steps can also coexist in the system to achieve various functions.

More specifically, as a terminating condition for controlling the heating element, the heating element 130 may be deactivated when the inner side temperature of the housing 110 is higher than the freezing point by a first preset value, for example, 4° C. to 5° C. higher. At this point, it is considered that the water inside the housing will not easily freeze; or the heating element 130 may be deactivated when the outer side temperature of the housing 110 is higher than the dew point temperature by a second preset value, for example, 10° C. higher. At this point, it is considered that water in the air outside the housing will not be easily precipitated to form condensation water on the housing. Alternatively, the aforementioned control steps can also coexist in the system to achieve various functions.

The refrigeration system, the control method thereof and the transport vehicle according to the present disclosure are mainly described in the above examples. While only some of the embodiments of the present disclosure have been described, those skilled in the art will understand that the present disclosure can be carried out in many other forms without departing from the spirit and scope thereof. Therefore, the illustrated examples and embodiments should be considered as illustrative rather than limiting, and the present disclosure can cover various modifications and replacements without departing from the spirit and scope of the present disclosure defined by individual appended claims.

1. A refrigeration system for a transport vehicle, the refrigeration system being configured to adjust a temperature inside a vehicle compartment of the transport vehicle, characterized in that the refrigeration system comprising an evaporator disposed in the vehicle compartment, and the evaporator comprising evaporator coils through which a refrigerant flows and a housing for accommodating the evaporator coils; wherein the housing is further provided with a heating element; and the refrigeration system further comprises a control module configured to control the heating element.

2. The refrigeration system according to claim 1, wherein the heating element is built into the housing, and/or the heating element is disposed on a surface of the housing.

3. The refrigeration system according to claim 2, wherein in a case that the material of the housing has a coefficient of thermal conductivity lower than a first preset value, the heating element is disposed on an inner side and an outer side of the surface of the housing respectively; or in a case that the material of the housing has a coefficient of thermal conductivity higher than a second preset value, the heating element is disposed on an inner side or an outer side of the surface of the housing; wherein the first preset value is less than the second preset value.

4. The refrigeration system according to claim 2, wherein in a case that the material of the housing has a coefficient of thermal conductivity lower than a third preset value, the housing is further provided with a heat conductive member, the heat conductive member is built in the housing, and/or the heat conductive member is disposed on the surface of the housing; wherein a heating element is disposed in the heat conductive member and is configured to transfer heat to the housing via the heat conductive member.

5. The refrigeration system according to claim 1, further comprising a water receiving tray, wherein a lower portion of the housing serves as the water receiving tray, or the water receiving tray is accommodated inside the housing; and wherein the heating element is disposed at the lower portion of the housing and is positioned near the water receiving tray.

6. The refrigeration system according to claim 1, further comprising a temperature sensor disposed on an inner side of the housing and/or an outer side of the housing; and
the control module controls activation/deactivation of the heating element based on an inner side temperature of the housing and/or an outer side temperature of the housing sensed by the temperature sensor.

7. The refrigeration system according to claim 1, wherein the heating element comprises carbon fibers.

8. A transport vehicle, comprising the refrigeration system according to claim 1, and a vehicle compartment.

9. The transport vehicle according to claim 8, wherein the vehicle compartment comprises a compartment door, on which a compartment door sensor is disposed; wherein when the compartment door is opened, the compartment door sensor transmits a signal to the control module of the refrigeration system, and the control module controls the heating element to be activated.

10. A control method of a refrigeration system for a transport vehicle, wherein the refrigeration system comprises an evaporator disposed in a vehicle compartment, and the evaporator comprises evaporator coils through which a refrigerant flows and a housing for accommodating the evaporator coils; wherein the housing is further provided with a heating element; characterized in that the heating element is activated when a defrosting mode of the refrigeration system is activated or during an operation in the defrosting mode; and/or the heating element continues being activated when a cooling mode is re-entered after the defrosting is completed; and/or the heating element is activated when the vehicle compartment is opened.

11. The control method according to claim 10, wherein the heating element is deactivated when the inner side temperature of the housing is higher than a freezing point temperature by a first preset value; and/or the heating element is deactivated when the outer side temperature of the housing is higher than the dew point temperature by a second preset value.

12. The control method according to claim 11, wherein the first preset value is 4° C.-5° C.; and the second preset value is 10° C.
